(19) United States
(12) Patent Application Publication
(10) Pub. No.: US 2026/0034388 A1
(43) Pub. Date: Feb. 5, 2026

(54) POWERED AIR PURIFYING RESPIRATOR

(71) Applicant: JSP LIMITED, Oxford, Oxfordshire (GB)

(72) Inventors: Stephen Hare, Oxford, Oxfordshire (GB); Oliver Beard, Oxford, Oxfordshire (GB)

(21) Appl. No.: 19/125,123

(22) PCT Filed: Oct. 12, 2023
(86) PCT No.: PCT/GB2023/052641

§ 371 Date: Apr. 28, 2025

(30) Foreign Application Priority Data
Oct. 28, 2022 (GB) 2215971.9

(51) Int. Cl. A62B 18/00; A62B 7/10; A62B 9/00

(52) U.S. Cl. CPC A62B 18/006; A62B 7/10; A62B 9/00

(57) ABSTRACT

A powered air purifying respirator comprises a housing having an inlet for admitting air from the exterior of the housing to the interior of the housing and an outlet for emitting air from the interior of the housing to a face mask connected to the housing. The inlet and outlet are on opposite edges of the housing. A filter is mounted within the housing so that air entering through the inlet must pass through the filter before it passes through the outlet. A pair of sockets extend along opposite sides of the housing. At least one of the sockets has a battery releasably retained therein. Optionally, there is one battery in each socket. A blower unit is mounted within the housing between the sockets for drawing air in through the inlet via the filter and directing air out through the outlet. A control system connects the batteries to power the blower unit. One face of the housing defines a sub-housing for locating the filter on the face of the housing so as to extend across the blower unit and sockets and across substantially all of the face of the housing. and further comprises a removable cover for closing the sub-housing and allowing replacement of the filter The cover also defines the air inlet.

### BACKGROUND

This invention relates to devices known as powered air purifying respirators (PAPRs). In particular, the invention relates to PAPRs with replaceable batteries.

PAPRs have been know for a number of years. They typically comprise a blower unit that draws air through a filter and provides filtered air to a face mask worn by a user. These allow a user to operate in areas where the air supply may be contaminated with dust or fumes that would otherwise make extended work in those areas uncomfortable or even dangerous.

There have been a number of proposals to make wearable PAPR units. While these allow a degree of flexibility of movement, there can be problems with operation, either because of the need to stop to replace discharged batteries, or through discomfort because of the size and weight of the unit.

Helmet-mounted PAPRs have been proposed in which the blower unit and power pack are mounted on a helmet that also carries the face masks. An example of these can be found in WO 2017/032981. Helmet-mounted units are limited in size and weight.

An alternative is a body wearable PAPR. These are worn on the back or waist of a user and can be larger. Examples of body wearable PAPRs can be found in WO 02/11815, WO 2005/065780, WO 2009/137770, and WO 2020/084482. Many of these are large and unwieldy and cannot be used while the batteries are being replaced. The position and shape of the filters can also be unwieldy in these previous units. This can be a particular issue when working in confined spaces where the PAPR can become tangled or damaged.

This invention aims to provide a compact PAPR that can be worn in a number of positions by a user. In addition, the invention aims to provide a PAPR that is convenient to use with battery power while minimising disruption to replace batteries.

### SUMMARY

One aspect of the invention provides a powered air purifying respirator, comprising:
a housing having
   an inlet for admitting air from the exterior of the housing to the interior of the housing; and
   an outlet for emitting air from the interior of the housing to a face mask connected to the housing;
wherein the inlet and outlet are on opposite edges of the housing;
a filter mounted within the housing so that air entering through the inlet must pass through the filter before it passes through the outlet;
a pair of sockets extending along opposite sides of the housing;
at least one of the pair of sockets having a battery releasably retained therein, optionally one battery in each socket;
a blower unit mounted within the housing between the sockets for drawing air in through the inlet via the filter and directing air out through the outlet; and
a control system for connecting the batteries to power the blower unit;
wherein one face of the housing defines a sub-housing for locating the filter on the one face of the housing so as to extend across the blower unit and sockets and across substantially all of the one face of the housing, and further comprises a removable cover for closing the sub-housing and allowing replacement of the filter, wherein the cover also defines the air inlet.

Mounting the blower unit between the battery sockets achieves a more compact unit.

The control system can be configured to selectively draw power from the batteries according to their state of charge. In this way, the PAPR can continue to operate when one battery is low in charge or is removed for replacement. The control system can be configured to detect when a first battery has been removed from its socket and to power the blower unit exclusively from a second battery until the first battery has been replaced.

The filter is located on one face of the housing and extends across the blower unit and sockets. This allows a relatively low-profile filter to be used without increasing the width of the PAPR while still presenting sufficient filter medium to filter the air entering the PAPR effectively.

The sub-housing can have an aperture to allow air to flow into the blower unit and the filter has a seal which seals against the sub-housing around the aperture when the cover is closed. In this way, locating the filter in the sub-housing seals around the blower unit inlet and forces inlet air to pass through the filter.

Each socket can be elongate and open at one end at one edge of the housing and are closed at an opposite end at an opposite edge of the housing and the closed end can have contacts for engaging corresponding contacts on the battery retained in the socket. The open end of the socket has a spring-loaded cover that is biased to close the open end of the socket. In this way, the battery makes contact only when it is completely inserted into the socket which can be held closed by the cover to protect the battery.

The control system can be configured such that when a battery is inserted into a socket and the corresponding contacts engage the contacts in the socket, the control system interrogates the battery to determine its state of charge. This allows the control unit to determine whether to draw power from one battery, the other, or both.

The system can further comprise a remote-control device, such as a mobile device app or fob, which can be operate by a user to control the control system via a wireless connection.

Further aspects and embodiments will be apparent from the detailed description.

### BRIEF DESCRIPTION OF DRAWINGS

FIG. 1 shows a PAPR connected to a helmet.

FIG. 2 shows an exploded view of the PAPR of FIG. 1 with parts omitted for clarity.

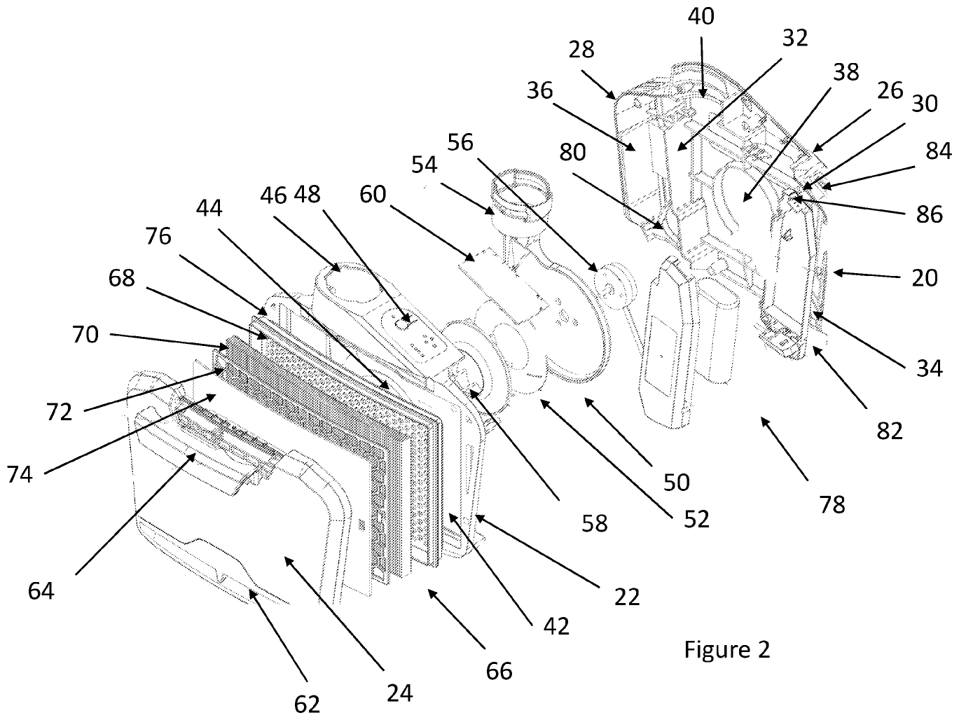

FIGS. 3-5 show a user wearing the PAPR on their waist or on their back in different positions/

### DETAILED DESCRIPTION

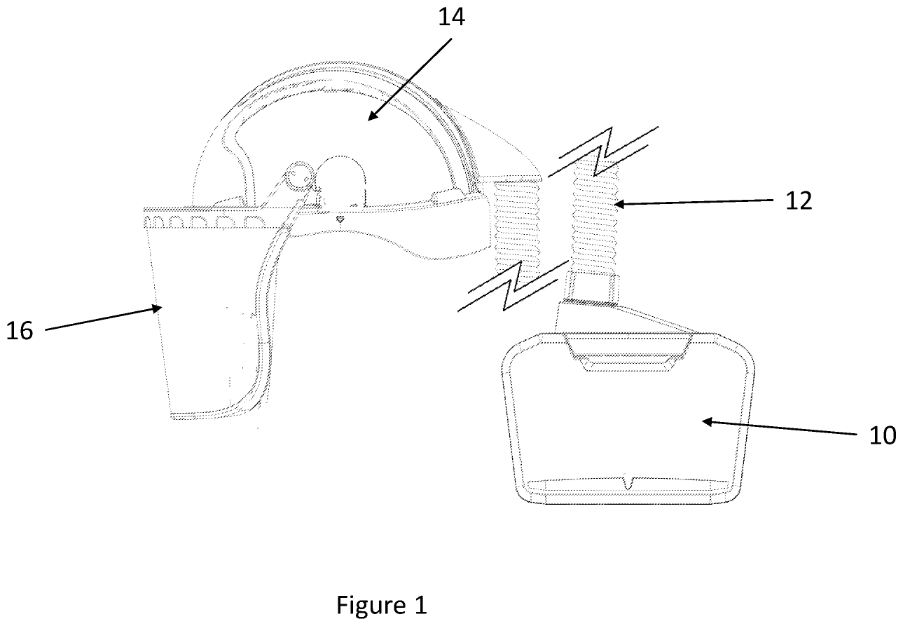

FIG. 1 shows a powers air purifying respirator (PAPR) 10 in its in-use configuration. The PAPR 10 is connected by a hose 12 to a helmet 14 having a mask 16 which seals around the face of a user. The helmet 14 includes ducting by means of which purified air from the hose 12 is directed into the mask 16.

The PAPR 10 comprises a housing defined by a main housing body part 20, an inner sub-housing 22 and a cover 24. The main housing body part 20 comprises a rear face 26 and an upstanding wall 28 defining a cavity. Internal walls 30, 32 extend across the cavity to define battery sockets 34, 36 extending along opposite edges of the housing with a central space 38 between the sockets 34, 36. An outlet 40 is defined in an upper edge of the body part 20 which communicates with the central space 38.

The inner sub-housing 22 fits on the wall 28 to close the sockets 34, 36 and central space 38. The inner sub-housing 22 has a recessed central region 42 and an opening 44 communicating between the central region 42 and the central space 38. An upper edge of the inner sub-housing 22 defines a top cover 46 which cooperates with the outlet 40 in the main housing body part 20 and provides a support for a control panel 48.

A blower unit 50, comprising an impeller 52, a volute 54 and a motor 56 are mounted in the central space 38 between the main housing body part 20 and the inner sub-housing 22. An impeller inlet 58 is connected to the opening 44 in the inner sub-housing 22 and the volute 54 directs air from the impeller 52 though the outlet 40.

The motor 56 is connected to a control circuit 60 mounted in the top cover 46 and connected to the control panel 48.

The cover 24 is mounted over the inner sub-housing 22 to close the recessed central region 42. Openings in the lower edge of the cover 24 define an air inlet 62. The cover 24 is secured to the inner sub-housing 22 by a latch 64.

A filter 66 is mounted in the recessed central region 42. The filter 66 comprises a perforated filter cage 68 which supports a pleated filter medium 70. A cage guard 72 holds the pleated filter medium on the perforated filter cage 68. A pre-filter 74 is secured to an outer face of the cage guard 72. The edge of the perforated filter guard 68 facing the inner sub-housing 22 has a seal 76 which engages the inner sub housing such that when the filter is held in place by the cover 24, air entering through the air inlet 62 must pass through the filter 66 in order to pass through the opening 44 and into the blower unit 50. Providing the seal 76 on the filter 66 means that the seal 76 is replaced when the filter 66 is replaced. This helps avoid degradation or damage of the seal 76 over time that may lead to unfiltered air entering the bower unit 50.

The filter extends across substantially all of the face of the unit. This means that a large area of filter can be provided without the need to increase the overall thickness of the unit.

To replace the filter 66, the cover 24 is opened using the latch 64 and the old filter 66 removed. The new filter is placed onto the inner sub-housing 22 such that the seal 76 is engaged and the cover 24 re-attached to hold the filter 66 in place.

Each battery socket 34, 36 can house a battery pack 78 (only one is shown). Both battery packs will have the same external shape and dimensions. The battery socket 34 is a mirror image of the battery socket 36 so that the orientation of the battery pack 78 is reversed from one socket 34 to the other 36. The battery pack contains a series of rechargeable cells and a battery control circuit (not shown). The rechargeable cells can be Li-ion cells or any other suitable rechargeable cell.

Each battery socket 34, 36 has an open end 80, 82 with a spring-loaded cover. The battery pack is inserted into the battery socket 34, 36 through the open end 80, 82 until it is fully within the battery socket 34, 36 and the spring-loaded cover closes and can be latched shut to retain the battery pack in the battery socket 34, 36. Each battery socket 34, 36 has battery contacts 84 at the end opposite to the open end 80, 82. The battery pack 78 has contacts 86 which engage the battery contacts 84 in the battery sockets 34, 36 when the battery pack 78 is fully inserted. The battery contacts 84 are connected to the control circuit 60.

The battery pack can be recharged via the contacts 86 in a charging unit, or via a separate charging socket, such as USB charger. A charging socket can be provided in the housing to recharge the battery packs 78 without the need to remove them.

The control circuit 60 operates to connect the battery pack 78 to operate the blower unit 50 by user operation of the control panel 48. The control unit 60 also operates to manage power consumption from the battery packs. If one pack is charged and the other is discharged or not present, the control circuit is configured only to draw from the charged battery pack. Where both are charged, the control circuit can be configured to draw from one, the other, or both according to user choice. The control circuit 60 will also detect when a battery pack 78 has been removed from a battery socket 34, 36 and will only draw power form the remaining battery pack 78. This allows continued operation of the PAPR while replacing a discharged battery pack and so avoids the need for a user to stop work when needing to replace a battery pack. When a battery pack 78 is inserted into a battery socket 34, 36, engagement of the contacts 84, 86 allows the control unit 60 to interrogate the battery pack 78 to determine its state of charge and operate the PAPR accordingly.

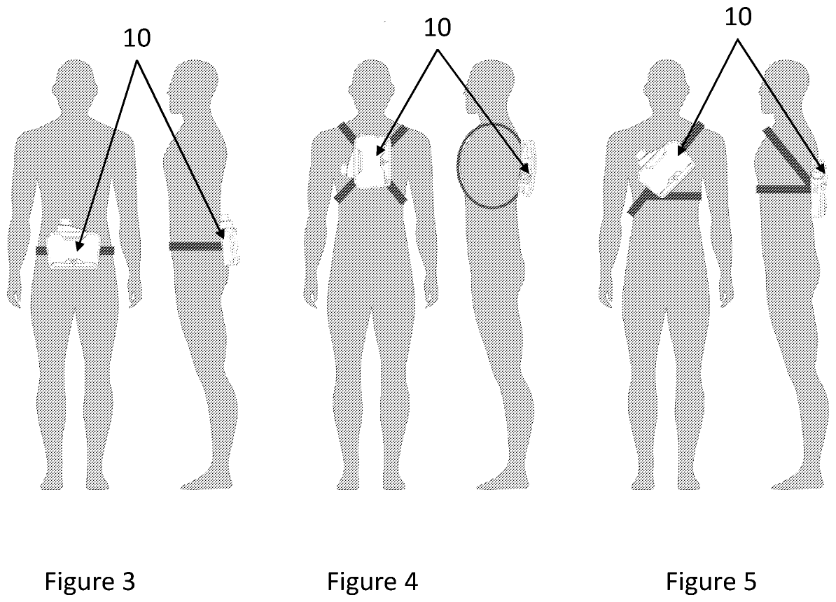

FIGS. 3-5 show different positions in which the PAPR can be worn by a user. Belt mountings can be provided on the rear of the housing so that the unit can be worn at the waist (FIG. 3), as a backpack (FIG. 4), or as an over-the-shoulder bandolier (FIG. 5). A user can decide which way to ear the unit according to the particular needs of operation. Because it can be difficult to reach a unit worn on the back, a remote control can be provided. Examples of these are dedicated wireless devices or apps on mobile devices or wearable devices such as smart watches.

Further changes can be made within the scope of the invention.

1. A powered air purifying respirator, comprising:
a housing having
an inlet for admitting air from the exterior of the housing to the interior of the housing; and
an outlet for emitting air from the interior of the housing to a face mask connected to the housing;
wherein the inlet and outlet are on opposite edges of the housing;
a filter mounted within the housing so that air entering through the inlet must pass through the filter before it passes through the outlet;
a pair of sockets extending along opposite sides of the housing;
at least one of the pair of sockets having a battery releasably retained therein;
a blower unit mounted within the housing between the sockets for drawing air in through the inlet via the filter and directing air out through the outlet; and
a control system for connecting the batteries to power the blower unit;
wherein one face of the housing defines a sub-housing for locating the filter on the one face of the housing so as to extend across the blower unit and sockets and across substantially all of the one face of the housing, and further comprises a removable cover for closing the sub-housing and allowing replacement of the filter, wherein the cover also defines the air inlet.

2. The powered air purifying respirator as claimed in claim 1, comprising a battery releasably retained in each socket.

3. The powered air purifying respirator as claimed in claim 1, wherein the control system is configured to selectively draw power from the batteries according to their state of charge.

4. The powered air purifying respirator as claimed in claim 1, wherein the control system is configured to detect when a first battery has been removed from its socket and to power the blower unit exclusively from a second battery until the first battery has been replaced.

5. The powered air purifying respirator as claimed in claim 1, wherein the sub-housing has an aperture to allow air to flow to the blower unit and the filter has a seal which seals against the sub-housing around the aperture when the cover is closed.

6. The powered air purifying respirator as claimed in claim 1, wherein each socket is elongate and open at one end at one edge of the housing and are closed at an opposite end at an opposite edge of the housing, and wherein the closed end has contacts for engaging corresponding contacts on the battery retained in the socket.

7. The powered air purifying respirator as claimed in claim 6, wherein the open end of the socket has a spring-loaded cover that is biased to close the open end of the socket.

8. The powered air purifying respirator as claimed in claim 6, wherein the control system is configured such that when the battery is inserted into the socket and the corresponding contacts engage the contacts in the socket, the control system interrogates the battery to determine its state of charge.

9. The powered air purifying respirator as claimed in claim 1, further comprising a remote-control device configured to be operated by a user to control the control system via a wireless connection.
